(19) United States
(12) Patent Application Publication
(10) Pub. No.: US 2012/0080370 A1
(43) Pub. Date: Apr. 5, 2012

(54) Water Treatment Apparatus

(76) Inventor: Chi-Chang Kuo, Taichung City (TW)

(21) Appl. No.: 12/898,527

(22) Filed: Oct. 5, 2010

(51) Int. Cl. B01D 33/46; B01D 33/15; C02F 1/00

(52) U.S. Cl. 210/327

(57) ABSTRACT

A water treatment apparatus includes a tank, a driving unit, a filtered-water pipe, a filtering unit and at least one scraping unit. The tank includes a wall, an inlet pipe extending through an upper portion, and an outlet pipe extending from a lower portion. The driving unit is located on an external side of the tank. The filtered-water pipe extends throughout the tank and is connected to the driving unit. The filtering unit includes flat filtering bags located around the filtered-water pipe. The flat filtering bags can be spun together with the filtered-water pipe. The scraping unit includes scrappers each located between and in contact with two adjacent ones of the flat filtering bags.

### BACKGROUND OF INVENTION

1. Field of Invention

The present invention relates to a water treatment apparatus and, more particularly, to a self-cleaning water treatment apparatus.

2. Related Prior Art

A conventional water treatment apparatus includes a filtering unit with a helically wound filtering film for filtering sludge out of water. To increase an effective area of the filtering unit for intercepting the sludge to increase the throughput of the production of filtered water, flat filtering bags are now used instead of the helically wound filtering film. The flat filtering bags are located along and around a filtered-water pipe. There is no need to provide a rigid shell to close the flat filtering bags. The flat filtering bags are simply located between two plates. Therefore, the effective area of the filtering unit for intercepting sludge is large. The size of the filtering unit consisting of the flat filtering bags is small. Advantageously, unfiltered water travels over the flat filtering bags at high speed and the throughput of the production of the filtered water is high. A water jet is used to wash the sludge away from external faces of the flat filtering bags.

To suppress the forming of filter cakes on the external faces of the flat filtering bags, air is pumped into the water treatment apparatus to increase stirring of the unfiltered water over the external faces of the flat filtering bags. Moreover, the flat filtering bags are spun. Thus, the external faces of the flat filtering bags are moved relative to the unfiltered water. The sludge and particles are removed from the external faces of the flat filtering bags. Hence, the flat filtering bags are not blocked. The throughput of the production of the filtered water is not reduced rapidly. Details of this technique can be found in Taiwanese Patent 13127687 for example.

There are various sources of unfiltered water including various undesired substances such as floc, solids and grease used to facilitate cutting. Where the flat filtering bags are used to treat unfiltered water including a lot of grease, the grease sticks the external faces of the flat filtering bags and affects the throughput of the production of the filtered water. Even worse, it is difficult to wash the grease away from the external faces of the flat filtering bags with a water jet. The life of the flat filtering bags is reduced.

The present invention is therefore intended to obviate or at least alleviate the problems encountered in prior art.

### SUMMARY OF INVENTION

It is the primary objective of the present invention to provide a self-cleaning water treatment apparatus.

To achieve the foregoing objective, the water treatment apparatus includes a tank, a driving unit, a filtered-water pipe, a filtering unit and at least one scraping unit. The tank includes a wall, an inlet pipe extending through an upper portion, and an outlet pipe extending from a lower portion. The driving unit is located on an external side of the tank. The filtered-water pipe extends throughout the tank and is connected to the driving unit. The filtering unit includes flat filtering bags located along and around the filtered-water pipe. The flat filtering bags can be spun together with the filtered-water pipe. The scraping unit includes scrappers each located between and in contact with two adjacent ones of the flat filtering bags.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a water treatment apparatus according to the preferred embodiment of the present invention;

FIG. 2 is a cross-sectional view of the water treatment apparatus taken along a horizontal shown in FIG. 1;

FIG. 3 is a side view of the water treatment apparatus shown in FIG. 1;

FIG. 4 is a partial cross-sectional view of the water treatment apparatus shown in FIG. 1;

FIG. 5 is a perspective view of a filtering unit and a scraping unit of the water treatment apparatus shown in FIG. 1;

FIG. 6 is a perspective view of a scraping unit of a water treatment apparatus according to a second embodiment of the present invention;

FIG. 7 is a side view of a water treatment apparatus according to a third embodiment of the present invention; and

FIG. 8 is a perspective view of a scraping unit of the water treatment apparatus shown in FIG. 7.

### DETAILED DESCRIPTION OF EMBODIMENTS

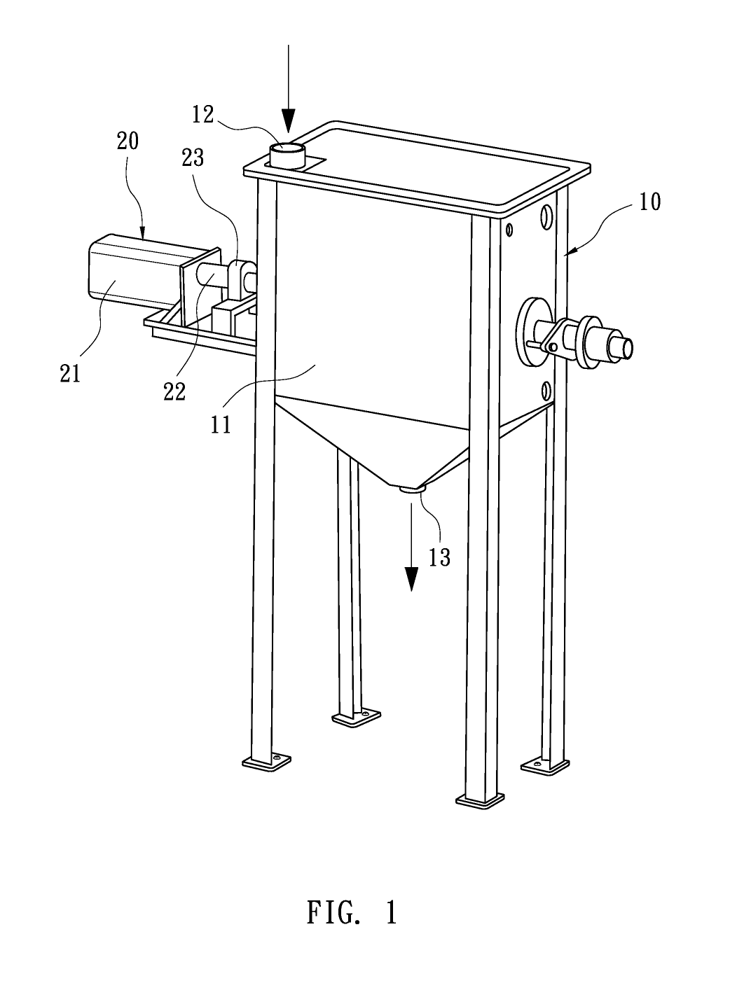

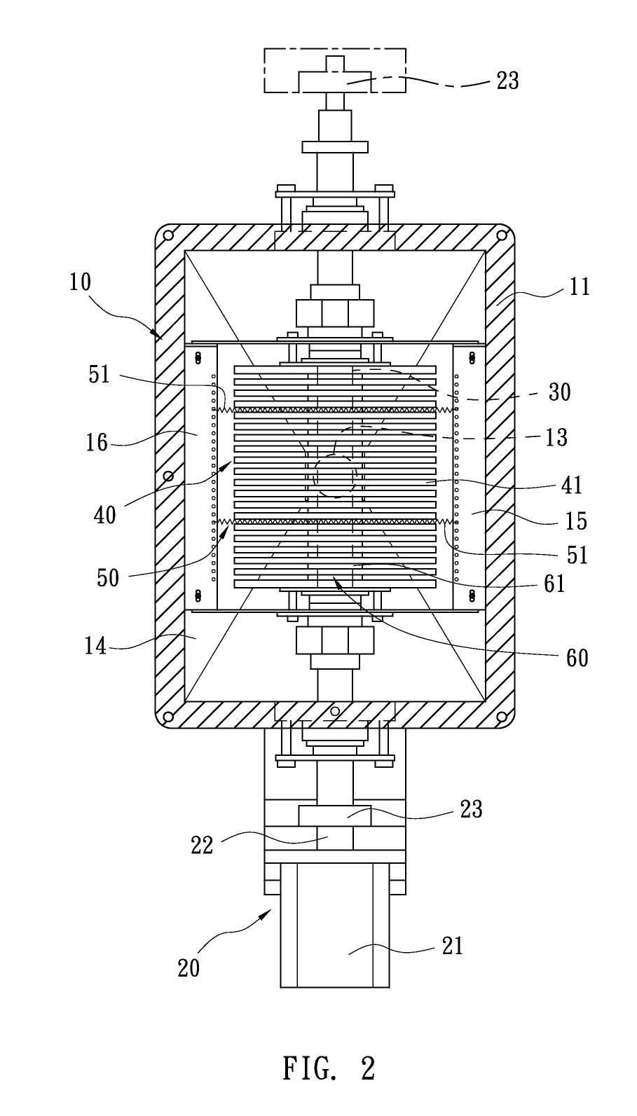

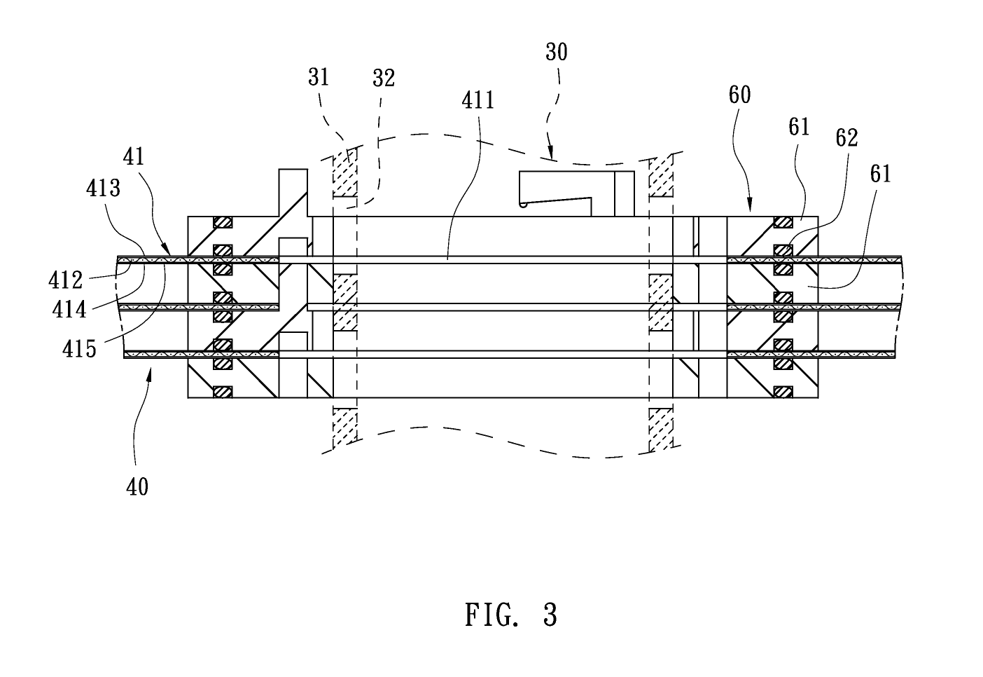

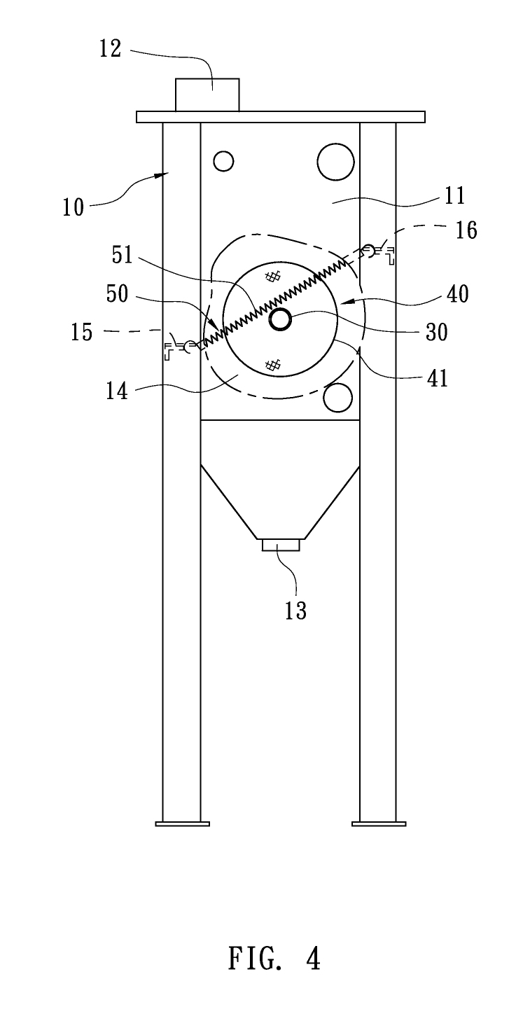

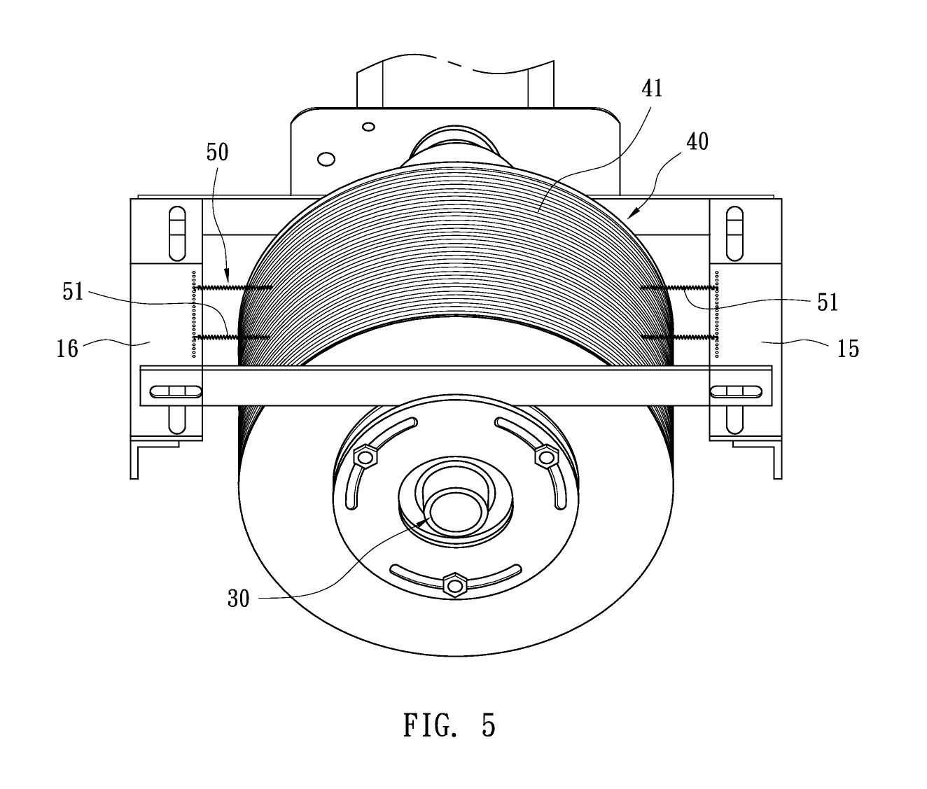

Referring to FIGS. 1 to 5, there is shown a water treatment apparatus according to a first embodiment of the present invention. The water treatment apparatus includes a tank 10, a driving unit 20, a filtered-water pipe 30, a filtering unit 40, a scraping unit 50 and a positioning unit 60. The tank 10 includes a wall 11 extending around and on a funnel-shaped lower portion. A space 14 is defined by the wall 11 and the lower portion of the tank 10. A cover is located on the wall 11. There is an inlet pipe 12 extending into the space 14 through the cover. Preferably, the inlet pipe 12 extends through a cutout in a corner of the cover. There is an outlet pipe 13 extending from the lower portion of the tank 10. Preferably, the outlet pipe 13 extends from the center of the lower portion of the tank 10. Two opposite bars 15 and 16 are located on an internal side of the wall 11. The bars 15 and 16 are located at different elevations.

The driving unit 20 is located on an external side of the wall 11. The driving unit 20 includes a combination 21 of a motor with a reduction gear, an axle 22 extending from the combination 21, and bearings 23 for rotationally supporting the axle 22 and the filtered-water pipe 30, respectively.

The filtered-water pipe 30 includes a middle section horizontally extending in the tank 10 and two terminal sections extending to the exterior of the tank 10 through the wall 11. The filtered-water pipe 30 includes a wall 31 and apertures 32 defined in the wall 31. One of the terminal sections of the filtered-water pipe 30 is connected to the axle 22, and this terminal section of the filtered-water pipe 30 includes a closed end. The other terminal section of the filtered-water pipe 30 includes an open end from which filtered water is released.

The filtering unit 40 includes flat filtering bags 41. Each of the flat filtering bags 41 includes a first film 413 and a second film 414. The films 413 and 414 include an annular configuration. An external edge of the first film 413 is joined to that of the second film 414. Thus, a space 415 is defined between the films 413 and 414. The space 415 includes an opening 411 defined between an internal edge of the first film 413 and that of the second film 414.

A film-supporting element 412 is sandwiched between the films 413 and 414 to support the films 413 and 414 and retain the space 415. The film-supporting element 412 also includes an annular configuration. An external edge of the film-supporting element 412 is joined to that of the films 413 and 414. The film-supporting element 412 is preferably a plastic net.

The tube 30 is inserted through the filtering unit 40. Thus, the apertures 32 are in communication with the spaces 415 via the openings 411.

The positioning unit 60 includes separators 61 alternately arranged with the flat filtering bags 41. Thus, the flat filtering bags 41 are separated from one another by the separators 61. Each of the separators 61 is formed with a buckle engaged with another separator 61. Thus, the flat filtering bags 41 are positioned by the separators 61. A seal 62 is attached to a side of each of the separators 61 while another seal 62 is attached to an opposite side of the separator 61. Each of the seals 62 is in water-tight contact with an external face of a related one of the films 413 and 414 of a related one of the flat filtering bags 41. Thus, unfiltered water cannot travel into the filtered-water pipe 30 via gaps between the flat filtering bags 41.

The scraping unit 50 includes scrappers 51 each located between two adjacent ones of the flat filtering bags 41 although only two of the scrappers 51 are shown for the clarity of the drawings. Each of the scrappers 51 is in contact with an external face of the first film 413 of an adjacent one of the flat filtering bags 41 and an external face of the second film 414 of another adjacent one of the flat filtering bags 41. Each of the scrappers 51 is a helical spring including an end hooked to the bar 15 and an opposite end hooked to the bar 16.

In use, unfiltered water is let into the tank 10 through the inlet pipe 12. The unfiltered water is forced through the flat filtering bags 41 and turned into filtered water while sludge is filtered out and left on the external faces of the films 413 and 414 of the flat filtering bags 41. The filtered water is sent into the filtered-water pipe 30 from the flat filtering bags 41 via the openings 411 and the apertures 31. The filtered water is sent into another tank from the filtered-water pipe 30 by suction.

To scrap the sludge from the external faces of the films 413 and 414 of the flat filtering bags 41, the filtering unit 40 is spun relative to the scraping unit 50, i.e., the flat filtering bags 41 are spun relative to the scrappers 51. Thus, the sludge is scrapped from the external faces of the films 413 and 414 of the flat filtering bags 41 by the scrappers 51. Then, the sludge is removed from the tank 10 through the outlet pipe 13.

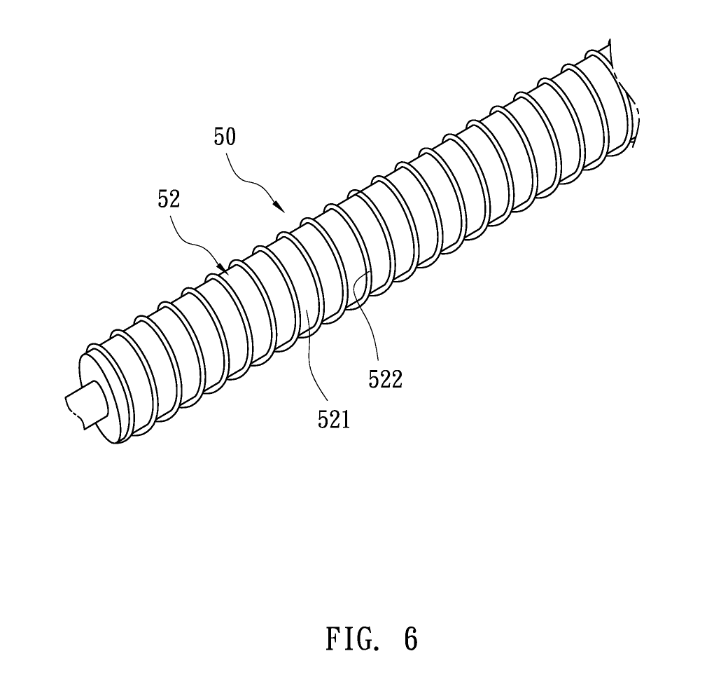

Referring to FIG. 6, there is shown a scrapping unit 50 of a water treatment apparatus according to a second embodiment of the present invention. The second embodiment is identical to the first embodiment except that the scrapping unit 50 includes scrappers 52 instead of the scrappers 51. Each of the scrappers 52 includes a rod 521 and a helical blade 522 extending on the rod 521. The helical blade 522 of each of the scrappers 52 is in contact with the external face of the first film 413 of an adjacent one of the flat filtering bags 41 and the external face of the second film 414 of another adjacent one of the flat filtering bags 41.

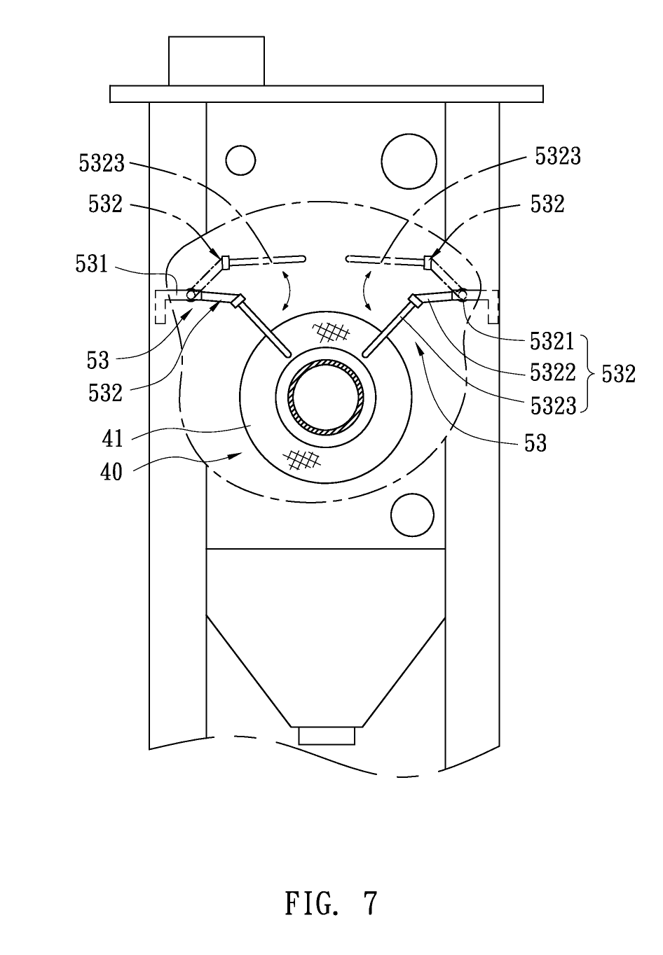

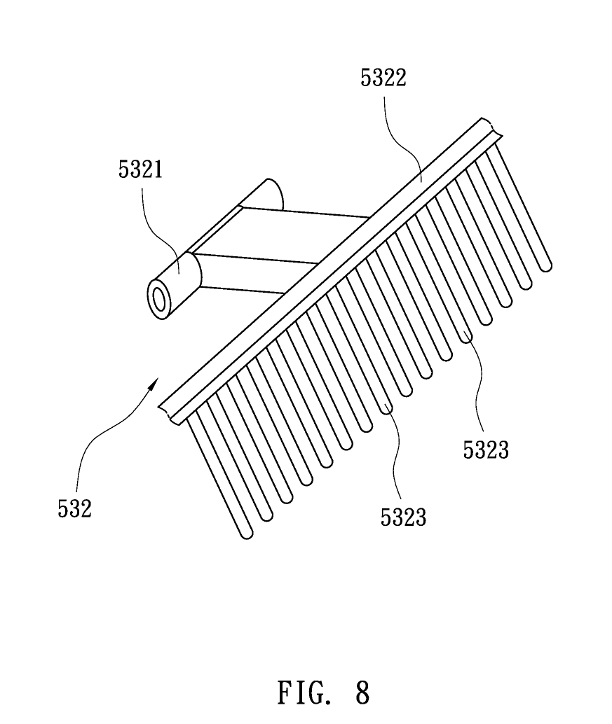

Referring to FIGS. 7 and 8, there is shown a scrapping unit 50 of a water treatment apparatus according to a second embodiment of the present invention. The third embodiment is identical to the first embodiment except including two scraping units 53 instead of the scrapping unit 50. Each of the scraping units 53 includes a bracket 531 located on the internal side of the wall 11 and a rocker 532 pivotally connected to the bracket 531. The rocker 532 includes a pivot 5321 pivotally connected to the bracket 531, a frame 5322 connected to the pivot 5321, and scrappers 5323 extending from the frame 5322. Each of the scrappers 5323 is preferably a circular tine. The rocker 532 is pivoted between an idle position and an active position relative to the bracket 531. In the idle position of the rocker 532, the scrappers 5323 are located away from the flat filtering bags 41. In the active position of the rocker 532, each of the scrappers 5323 is in contact with the external face of the first film 413 of an adjacent one of the flat filtering bags 41 and the external face of the second film 414 of another adjacent one of the flat filtering bags 41.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A water treatment apparatus including:
a tank includes a wall, an inlet pipe extending through an upper portion, and an outlet pipe extending from a lower portion;
a driving unit located on an external side of the tank;
a filtered-water pipe extending throughout the tank and being connected to the driving unit;
a filtering unit includes flat filtering bags located around the filtered-water pipe, wherein the flat filtering bags can be spun together with the filtered-water pipe; and
at least one scraping unit including scrappers each located between and in contact with two adjacent ones of the flat filtering bags.

2. The water treatment apparatus according to claim 1, including a positioning unit including:
separators alternately arranged with the flat filtering bags; and
seals each attached to a related one of the separators and in contact with a related one of the flat filtering bags.

3. The water treatment apparatus according to claim 1, wherein each of the flat filtering bags includes:
a first film;
a second film with an external edge joined to an external edge of the first film; and
a film-supporting element located between the first and second films and formed with an external edge joined to that of the first and second films.

4. The water treatment apparatus according to claim 1, wherein each of the scrappers is a helical spring.

5. The water treatment apparatus according to claim 1, wherein each of the scrappers includes:
a rod; and
a helical blade extending on the rod.

6. The water treatment apparatus according to claim 1, wherein the tank includes two bars attached to an internal side of the wall, wherein each of the scrappers includes an end connected to one of the bars and another end connected the other bar.

7. The water treatment apparatus according to claim 6, wherein the bars are located at different elevations.

8. The water treatment apparatus according to claim 1, wherein the scraping unit includes:
a bracket attached to an internal side of the wall of the tank;
a rocker pivotally connected to the bracket; and
a frame connected to the rocker, wherein the scrappers extend from the frame.

9. The water treatment apparatus according to claim 8, wherein the scrappers are circular tines.

10. The water treatment apparatus according to claim 1, wherein the outlet pipe is located in a center of a lower portion of the tank.

11. The water treatment apparatus according to claim 1, wherein the section of the filtered-water pipe that is connected to the driving unit is closed.

12. The water treatment apparatus according to claim 1, wherein the driving unit includes:
a combination of a motor with a reduction gear; and
an axle for connecting the combination to the filtered-water pipe.
